(19) United States
(12) Patent Application Publication
(10) Pub. No.: US 2021/0293383 A1
(43) Pub. Date: Sep. 23, 2021

(54) SORPTIVE GAS STORAGE DEVICE

(71) Applicant: AAQIUS & AAQIUS SA, Geneve (CH)

(72) Inventors: Michael Francis LEVY, Paris (FR); Jorn OUBRAHAM, Paris (FR); Carsten POHLMANN, Issy Les Moulineaux (FR); Jean-Baptiste DEMENTHON, Paris (FR)

(73) Assignee: AAQIUS & AAQIUS SA, Geneve (CH)

(21) Appl. No.: 17/264,820

(22) PCT Filed: Jul. 31, 2019
(86) PCT No.: PCT/EP2019/070603

§ 371 Date: Jan. 31, 2021

(30) Foreign Application Priority Data
Jul. 31, 2018 (FR) 1857183

(51) Int. Cl. F17C 11/00; F17C 1/12

(52) U.S. Cl. CPC F17C 11/005; F17C 2203/0304; F17C 2227/0302; F17C 1/12

(57) ABSTRACT

The invention relates to a sorptive gas storage device (1) comprising: a sorptive gas storage structure (10) comprising a sorptive gas storage material, said storage structure (10) having a circumferential edge (B), —heating means (3) configured to heat the storage material, and facilitate the desorption of the gas, said heating means (3) comprising: •a first heating part (30) arranged in the storage structure (10), at a distance from the circumferential edge (B), •a second heating part (32) arranged in the storage structure (10), at a distance from the circumferential edge (B) on the one hand and from the first heating part (30) on the other hand, the first heating part (30) and the second heating part (32) defining between them a space whereinto a first portion (11) of the storage structure (10) extends.

### FIELD OF THE INVENTION

The invention relates to the storage of gas by sorption.

The invention relates more specifically to a sorption gas storage device, a gas storage and/or supply system, and a method for manufacturing a sorption gas storage device.

### STATE OF THE ART

The use of gases in industry, whether in the mobility, energy, chemical or production sectors, is subject to multiple constraints. In this respect, many gas storage devices have already been proposed. Some of these devices may comprise a solid material to store a gas.

Such solid storage devices must present specific properties in order to meet the constraints induced by the gas and related to the conditions of its use. Gas stored in solid form can, for example, when used as an energy carrier, power a fuel cell. In the mobility sector, it can also be used within a motor vehicle.

Depending on the intended use, storage structures are dimensioned in different ways due to the choice of storage material and its size. Some of these materials can be used to both store and retrieve gas, depending on the temperature and pressure conditions to which these materials are subjected. Generally speaking, such materials store gas during an exothermic reaction and release it during an endothermic reaction. These reactions take place, for example, by sorption of the gas onto the material.

In any case, the management of heat distribution within the storage material is an essential issue to guarantee the performance of such devices. In this respect, it is for example known to arrange the storage material inside a confined enclosure comprising heating walls. In other examples of devices, the storage material is arranged around a cylindrical heating tube. In all cases, the heating can be adjusted according to the storage requirements.

The known systems are however exposed to efficiency problems, especially with regard to homogenization of the heat transfer from the heating means to the entire storage material. For example, the portion of the material furthest from the said heating means is less well heated than the nearest portion. In addition, the known systems are exposed to problems of robustness and longevity of operation of the storage structures, but also of safety of use, complexity of manufacture, and economic and energy efficiency in the implementation of these systems.

### DESCRIPTION OF THE INVENTION

One object of the invention is to overcome at least one of the above-mentioned disadvantages.

Another object of the invention is to improve heat transfer within a structure for storing a gas by sorption.

Another object of the invention is to promote the modularity of a gas storage structure.

In particular, the invention provides a sorption gas storage device comprising:
a sorption gas storage structure comprising a sorption gas storage material, the said storage structure having a circumferential edge,
heating means configured to heat the storage material, and to facilitate desorption of the gas, the said heating means comprising:
a first heating portion arranged in the storage structure, spaced from the circumferential edge,
a second heating part arranged in the storage structure, at a distance from the circumferential edge on the one hand, and from the first heating part on the other hand,
the first heating part and the second heating part defining between them a space into which a first portion of the storage structure extends.

Such a device reduces the losses related to heating, while ensuring a homogenization of heat transfer within the storage structure.

The device according to the invention may further comprise any of the following features, taken alone or in combination:
the first heating part and the second heating part are connected to each other by a third heating part,
the storage structure presents a preferred direction defining a longitudinal axis, with the heating means presenting a substantially annular structure along the longitudinal axis,
the composition and/or distribution of the storage material in the first portion of the storage structure are different from the composition and/or distribution of the storage material in the rest of the storage structure, in order to optimize the distribution of heat from the heating means within the storage structure,
it also comprises:
an enclosure comprising an outer wall, the storage structure being disposed within the enclosure, and
a thermal insulation layer disposed between the storage structure and the outer wall of the enclosure, the said layer being further configured to diffuse gas,
the insulating layer comprises a porous structure,
the insulation layer comprises a grooved structure,
the insulating layer is a film,
the insulating layer is formed on an inner wall of the enclosure, for example by treatment of the said wall, or by depositing an additional coating,
the storage structure comprises:
a first layer comprising a sorption storage material,
a second layer comprising:
   a first portion of a second layer, in contact with the first layer, and comprising a thermally conductive material, having a higher thermal conductivity than the storage material, to increase heat transfer within the storage structure, and
   a second part of second layer, comprising a material being:
      compressible in order to deform under the action of forces exerted by the storage material during variations in the volume of the storage material during gas sorption and desorption phases,
      of higher compressibility than the material of the first part, and
      thermally conductive, with higher thermal conductivity than the storage material, to increase heat transfer within the storage structure, and
the storage structure comprises:
a plurality of first layers, each first layer comprising the gas sorption storage material in a pre-compressed powder form, and
a plurality of second layers, each second layer comprising a material being:
   compressible in order to deform under the action of forces exerted by the storage material during variations in the volume of the storage material during gas sorption and desorption phases, and
   thermally conductive, with higher thermal conductivity than the storage material, in order to increase heat transfer within the storage structure,
      the first and second layers being arranged in an alternating pattern.

The invention further relates to a method for manufacturing a device as previously described comprising the steps of:
compressing a powder of sorption gas storage material so as to form a first layer of sorption gas storage material in a pre-compressed powder form,
disposing a second layer adjacent to the first layer, the said second layer comprising a thermally conductive material having a higher thermal conductivity than the storage material.

The invention further relates to a gas storage and/or supply system comprising a device as previously described, and a gas utilization unit.

### DESCRIPTION OF THE FIGURES

Other features, objects and advantages of the present invention will appear on reading the detailed description which follows and in relation to the appended drawings which are given as non-limiting examples and on which:

FIG. 1 shows a sectional view of a first example of a gas storage device according to the invention,

FIG. 2 shows a sectional view of an example of a gas storage structure,

FIG. 3 shows a schematic view of a gas storage structure in different operating states,

FIG. 4 is a top view of a second example of a gas storage device according to the invention,

FIG. 5 is a top view of a third example of a gas storage device according to the invention,

FIG. 6 shows a sectional view of a fourth example of a gas storage device according to the invention,

FIG. 7 is an enlarged sectional view of a fifth example of a gas storage device according to the invention,

FIG. 8 is an enlarged sectional view of a sixth example of a gas storage device according to the invention,

FIG. 9 schematically illustrates a gas storage and/or supply system according to the invention, and

FIG. 10 is a flowchart illustrating an example of the implementation of a method for manufacturing a gas storage device according to the invention.

### DETAILED DESCRIPTION OF THE INVENTION

With reference to the figures, we will now describe a sorption gas storage device 1, a gas storage and/or supply system 5, as well as a method E for manufacturing a sorption gas storage device.

The stored gas can be of any kind and type. For example, storage device 1 may store hydrogen, ammonia, water vapor, oxygen, and/or carbon dioxide alone, or in combination.

Gas Storage Structure

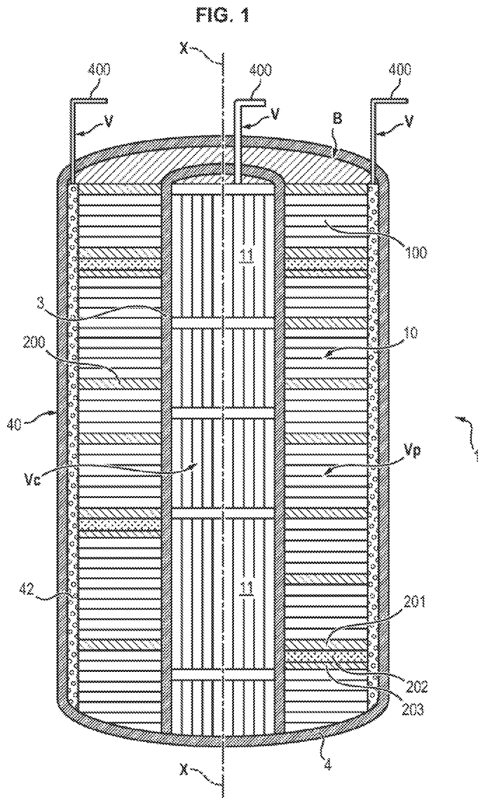

With reference to FIG. 1, a sorption gas storage device 1 comprises a sorption gas storage structure 10 comprising a sorption storage material.

The sorption storage structure further comprises a circumferential edge B that surrounds the said storage structure 10.

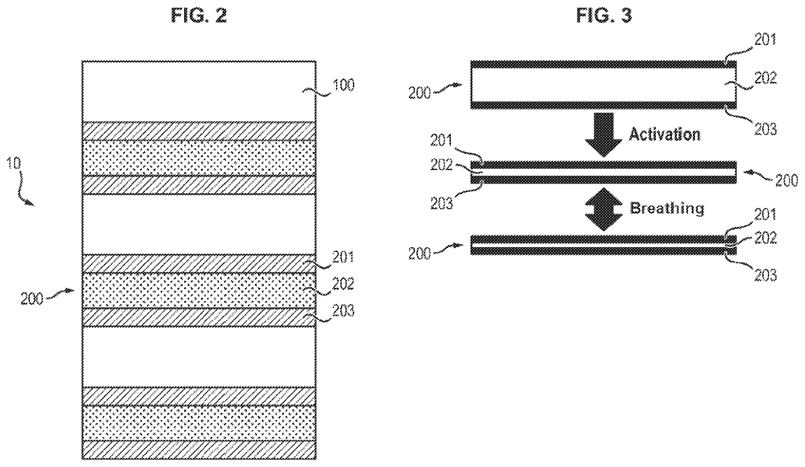

In addition, with reference to FIGS. 1 and 2, the sorption gas storage structure 10 may comprise a first layer 100 and a second layer 200.

The first layer 100 is then configured to store gas by sorption. For this purpose, it can comprise the sorption storage material.

Advantageously, the storage material can be in pre-compressed powder form. Indeed, this form facilitates the transport of the storage material because it is easier to handle and has a smaller volume. In addition, this form is more suitable for sorption storage operation, as it is more stable, facilitates heat transfer and makes the expansion of the storage material more homogeneous.

In addition, the material can present an optimized porosity to increase the volumetric storage capacity of the storage structure, but also to accommodate the volume variations of the second layer 200. For example, the porosity of the storage material is between 10 vol. % and 50 vol. %, preferably between 25 vol. % and 35 vol. %. Porosity is defined as the ratio of the volume of air not occupied by the storage material within a given volume of the storage material to the said given volume. In other words, porosity corresponds to the ratio of the volume not occupied by the storage material to its apparent volume, i.e. porosity is equal to the ratio of the theoretical density from which the apparent density is subtracted to the theoretical density. In any case, the pre-compressed powdered form makes it possible to control the porosity of the storage material.

In addition, the storage material may comprise:
a material adapted to form a metal hydride, preferably of the MgH₂, NaAlH₄, LiNH₂, and/or LiBH₄ type, and/or
a material suitable for forming an intermediate alloy, preferably of the TiMn₂, TiCr₂, LaNi₅, FeTi, TiV, and/or TiZr type, and/or
a material suitable for forming an ammonia salt, preferably of the BaCl₂ type, and/or CaCl₂, or
a material adapted to form a hydroxide, preferably of the CaO type, and/or Ca(OH)₂, or
a material suitable for forming an oxide, preferably of the PbO, and/or CaO type.

The applicant has indeed found that the above materials are particularly suitable for storing and/or supplying gas such as hydrogen, ammonia, water vapour, oxygen, and/or carbon dioxide. This is not, however, limiting, since such materials can also be particularly suitable for other types of gases.

The second layer 200 may comprise a material being:
thermally conductive, with a higher thermal conductivity than the storage material, in order to increase heat transfer within the storage structure 10, and
compressible in order to deform under the action of forces exerted by the storage material during variations in the volume of the storage material during the gas sorption and desorption phase.

Thanks to the second layer 200, gas sorption and desorption phenomena by the storage material, which involve significant heat flows, are facilitated. In fact, the heat transfers are homogeneously distributed throughout the entire storage structure 10, which reinforces its efficiency and durability. In fact, heat can be easily conveyed and extracted from the first layer 100, which ensures the rapid storage and/or retrieval of gas within the storage structure 10. The energy stored by a given mass of storage material is therefore increased. Advantageously, the dimensions, shape, and relative positioning of the first layer 100 and the second layer 200 allow in particular to optimize the heat transfers within the storage structure 10. For example, when the first layer 100 and the second layer 200 extend in a preferred longitudinal direction, as shown in FIG. 1, the layer thickness in the longitudinal direction is a possible lever for optimizing heat flows within the storage structure 10. Alternatively, or in combination, providing a storage material porosity gradient within the first layer 100, in a radial direction relative to the longitudinal direction, is also a possible route for optimizing heat exchange within the storage structure 10. Indeed, it can be observed that, when the first layer 100 and the second layer 200 extend in a longitudinal direction, the radial direction constitutes a preferred direction of heat exchange within the storage structure 10. In any case, most of the heat emitted or received by the first layer 100 is transferred by the second layer 200.

In addition, the second layer 200 acts as a buffer during the operation of the storage structure 10. Indeed, the second layer 200 compensates for the variations in volume of the storage material during the gas sorption and desorption phases, thus preserving the mechanical coherence of the storage structure 10. In this way, the volumetric capacity of the storage material is advantageously increased, since it is no longer necessary to create empty spaces within storage structure 10. Finally, the second layer 200 distributes the mechanical forces resulting from volume variations of the storage material during operation.

In addition, the second layer 200 can comprise a matrix comprising graphite, for example natural graphite, for example expanded natural graphite. Alternatively, or as a complement, the second layer 200 may comprise a metal, for example aluminium or copper. The applicant has found that these materials have adequate compressibility and/or heat transfer properties to fulfil the functions of the second layer 200.

Alternating Structure

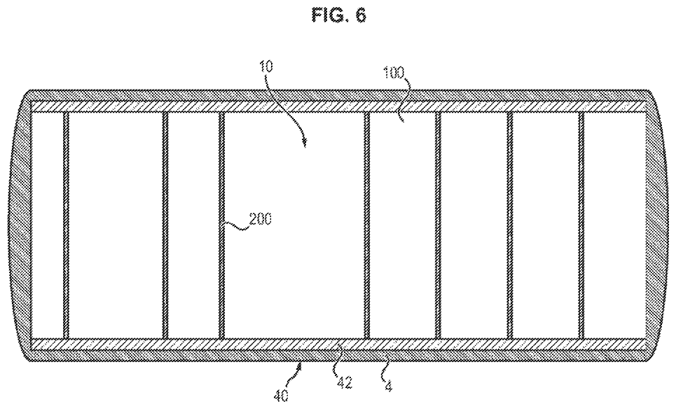

As can be seen in FIGS. 1 and 2, but also in FIGS. 6 to 8, storage structure 10 can comprise the first layer 100 and the second layer 200, alternately. Preferably, the storage structure 10 then comprises alternating first layers 100 and second layers 200, with the first layers 100 preferably separated two by two by one of the second layers 200. In other words, the plurality of first layers 100 and the plurality of second layers 200 are arranged in an alternating pattern. In particular, the alternating pattern facilitates the distribution of thermal and mechanical stresses within the storage structure 10. In addition, an alternating structure is easily reproducible on an industrial scale, both in the manufacturing and maintenance stages of the storage structure 10. Moreover, such a structure can easily be adapted according to the storage and/or gas supply performance requirements. Finally, such a distribution allows a compactness of the storage structure 10 that can be particularly advantageous for applications such as transportation, for example automotive.

Advantageously, the storage structure 10 comprises an alternation of wafers, each first layer 100 and/or each second layer 200 preferably forming a wafer. Preferably, but nevertheless optional, the wafers are mechanically independent of each other. Such a configuration can particularly, facilitate the handling of the different elements of the storage structure during the various operations related to the manufacture, maintenance and/or recycling of the storage structure 10. In addition, the wafer configuration promotes geometric optimization of the repartition and distribution of materials within the storage structure 10. As a complement, this configuration is more suitable for sorption storage operation because it is more stable, facilitates heat transfer, and makes the expansion of the storage material more homogeneous. Thus, the gas can be better distributed throughout the storage structure 10 when loading the storage material.

Second-Layer Parts

With reference to FIGS. 2 and 3, the second layer 200 may comprise a first part of a second layer 201, 203 in contact with the first layer 100, and a second part of the second layer 202.

In this configuration, the first part 201, 203 can then comprise a thermally conductive material, with a higher thermal conductivity than the storage material, in order to increase heat transfer within the storage structure. The second part 202 may comprise a compressible material in order to deform under the action of forces exerted by the storage material during variations in the volume of the storage material during the gas sorption and desorption phase. In addition, the second part 202 material is, in this case, advantageously of higher compressibility than the first part material. By compressibility, we understand the capacity of a material to decrease its volume when it is subjected to a given compression stress. Thus, for the same compressive stress, the decrease in volume of the second part 202 material is greater than the decrease in volume of the first part material 201, 203. In other words, in order to achieve a given rate of decrease in volume of the part 201, 203 and part 202 material, greater compressive forces are required for the part 201, 203 material than for the part 202 material. In any case, the second part 202 material may also be thermally conductive, with a higher thermal conductivity than the storage material, in order to increase heat transfer within the storage structure 10.

The functions of the second layer 200 are then partially distributed between the first part 201, 203 and the second part 202. In this way, each of these functions can be optimized independently of the other, which improves the overall efficiency of the storage structure 10, and further allows the storage structure 10 to be further adapted according to the gas supply and/or storage requirements. In addition, the presence of a thermally conductive material in each of the two parts 201, 202, 203 ensures that heat exchanges within the storage structure 10 are facilitated in order to distribute the heat evenly throughout the storage structure 10.

The material in the first part 201, 203 can be identical to the material in the second part 202. This results in an advantageous cost reduction and simplification of the manufacturing of the storage structure 10. Alternatively, the first part 201, 203 material, can be different from the second part 202 material. This facilitates the adaptation of the storage structure 10 to optimize its storage and/or supply capacity for a given gas.

Furthermore, the material in the first part 201, 203, and/or the second part 202 material, may comprise a matrix comprising graphite, for example natural graphite, for example expanded natural graphite. Alternatively, or as a complement, the material in the first part 201, 203 may comprise a metal, for example aluminum or copper. Alternatively, or as a complement, the second part 202 material may comprise a foam. The applicant has determined that these materials have adequate compressibility and/or heat transfer properties to perform the functions of the first part 201, 203 and/or the second part 202 of a storage structure 10.

In addition, the material of the first part 201, 203 may have lower porosity than the material of the second part 202. Porosity is a parameter that influences both the compressibility and the thermal properties of a material. Consequently, this difference in porosity favors the deformation of the second part 202 under the action of forces exerted by the storage material during variations in the volume of the storage material during the gas sorption and desorption phases, and allows the first part 201, 203 to increase the heat transfers within the storage structure 10. Specifically, the material of the first part 201, 203 may have a porosity of less than 50%, preferably less than 15%, and in a preferred manner less than 5%.

With reference to FIG. 3, the mechanical properties of the second layer 200 evolve during the different operating cycles of the storage structure 10.

In fact, the first operating cycles of storage structure 10 allow activation of the first layer 100. More precisely, during the first loading and/or unloading cycles of the storage structure 10, the storage material comprised in the first layer 100 acquires its full storage capacity by sorption. This initial conditioning can be implemented during loading and/or unloading cycles that can be long-lasting and/or carried out at high temperature and/or high pressure. In this respect, it should be noted that when the storage material is in its pre-compressed powder form, activation is facilitated because the number and duration of the first loading and/or unloading cycles is reduced. Gradually, the quantity of gas stored and then released by the first layer 100 increases, as successive loading and/or unloading takes place, until an expected storage level is reached under given temperature and pressure conditions. This expected level corresponds to the maximum quantity of gas that can be stored in the first layer 100 at a given temperature and pressure. Once this level is reached, the storage material is activated. However, this or these first cycle(s) of operation lead(s) to significant changes in the volume of the first layer 100. This leads to a plastic compression of the second layer 200, mainly by plastic compression of the second part of the second layer 202, as can be seen in FIG. 2.

Subsequently, the volume variations of the first layer 100, during storage and/or gas release, are less significant than during activation of the storage material. This introduces the notion of first layer 100 breathing. These small volume variations are compensated by an elastic deformation of the second layer 200 as shown in FIG. 3.

Thus, the first part 201, 203 may have a thickness of less than 5 millimeters, preferably about 2 millimeters, and in a preferred manner about 1 millimeter, before activation of the storage material. The second part 202 can, for its part, present, before activation of the storage material, a thickness of between 2 and 10 millimetres, preferably between 2 and 8 millimetres, and in a preferred manner between 2 and 4 millimetres. The applicant has found that these thicknesses guarantee the best thermal conductivity within the storage structure 10, but also a good compensation of the forces exerted by the storage material during variations in the volume of the storage material during gas sorption and desorption phases. In any case, the plastic compression of the second layer 200 leads to a reduction in height of the second layer 200 of the order of 20 to 60% compared to its initial height, before activation, and the elastic compression leads to a reduction in height of the second layer 200 of the order of 80 to 99% compared to its initial height, before activation.

In addition, the material of the second part 202 may present, before activation of the storage material, porosity of more than 70%, preferably more than 80%, and in a preferred manner more than 95% and, after activation of the storage material, a porosity of more than 20%, preferably more than 30%, and in a preferred manner between 45% and 60%. The applicant has found that these porosities guarantee the best thermal conductivity within the storage structure, but also a good compensation of the forces exerted by the storage material during variations in the volume of the storage material during gas sorption and desorption phases.

As can be seen in FIGS. 1 to 3, the first part 201, 203 can be a first sub-layer and/or the second part 202 can be a second sub-layer. This guarantees a structural homogeneity that facilitates manufacturing, maintenance and/or recycling operations of the storage structure 10. In addition, the functions of the second layer 200 can be ensured while maintaining good compaction of the storage structure 10. However, this is not limiting, since other forms of the first part 201, 203 and the second part 202 are possible. For example, the second layer 202 can also be structured in angular sectors, each sector corresponding to one or the other of the first part 201, 203 and of the second part 202.

Advantageously, with reference to FIGS. 1 to 3, for at least one second layer 200, the second underlayer 202 can be arranged between the first underlayer 201 and a third underlayer of the second layer 203, in contact with another of the at least one first layer 100, and comprising a thermally conductive material with a higher thermal conductivity than that of the storage material, in order to increase the heat transfer within the storage structure. In this “sandwich” configuration of the second layer 200, the second underlayer 202 is not in contact with the first layer 100. This configuration allowing for optimization of the heat transfer through the storage structure 10.

Heating Means

With reference to FIGS. 1, 4 and 5 a sorption gas storage device 1 may furthermore comprise heating means 3 configured to heat the storage material and facilitate gas desorption.

The heating means 3 may comprise a device capable of carrying a heat transfer fluid, such as water. For example, such a device may take the form of a radiator, or a double-walled, cylindrical body of revolution surrounding the storage structure 1. When the storage structure 1 is connected to a gas utilization unit 6 that releases energy in the form of heat (for example, fuel cell, combustion engine, exhaust line, etc.), such a heating device may comprise a closed heat transfer fluid circuit connecting the storage structure 1 to the gas utilization unit 6. During operation, the heat emitted from the gas utilization unit 6 is captured by the circulating heat transfer fluid and then radiated into the storage structure 1 via the same circulating heat transfer fluid. This not only cools the gas utilization unit 6, but also facilitates the desorption of the gas by heating. This type of heating means 3 thus offers the advantage of being energy-optimized, i.e. it does not require the use of excess energy during the operation of the storage structure 1. In addition, it allows the dimensions of a possible cooling system of the gas utilization unit 6 to be reduced.

Alternatively, or as a complement, the means of heating 3 comprises the means of ventilation by the air surrounding the storage device 1. The ventilation means have the advantage of being simple and inexpensive.

Alternatively, or as a complement, the heating means 3 may comprise a resistor, for example of electrical type, connected to an electrical power generator. This type of heating means 3 is simple and quick to implement. A resistor also offers the advantage of being easily modulable according to the desired applications.

Alternatively, or as a complement, when the stored gas is a fuel, and the storage device 1 is connected, in addition to the gas utilization unit 6, to a gas combustion unit (not shown), it is possible to connect the heating means 3 to the said gas combustion unit, so as to recover the heat released by the combustion of the gas. This type of heating means 3, dedicated to the storage device 1, makes it possible to increase the temperature within the storage structure 10 very quickly.

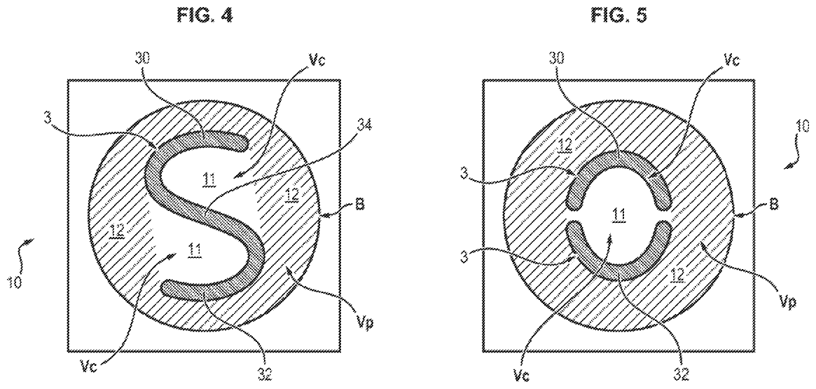

As shown in FIGS. 4 and 5, the heating means 3 may comprise:
a first heating section 30 arranged in the storage structure 10, at a distance from the circumferential edge B, and
a second heating section 32, also arranged in the storage structure, at a distance from the circumferential edge on the one hand, and from the first heating section 30 on the other hand.

The term “at a distance” means that the first heating section 30 and the second heating section 32 are not in direct contact with the circumferential edge B or with each other. Thus, the first heating section 30 and the second heating section 32 define a space between them, into which a first portion 11 of the storage structure 10 extends.

This arrangement of the heating means 3 within the storage structure 10 results in a central volume Vc and a peripheral volume Vp of the storage structure 10. Since the heating means 3 are neither arranged on a wall of the storage structure 10, nor in the center of the storage structure 10, it is possible to heat the storage structure 10 more homogeneously. Thus, the heat flow emitted by the heating means 3 benefits the entire storage structure 10. The stored and/or supplied gas is therefore better distributed throughout the storage structure 10, so that the service life of the storage structure 10 can be extended.

In addition, the first heating section 30 and the second heating section 32 can be connected to each other by a third heating section 34. Thus, the heating means 3 can have a substantially annular cross section, as in FIG. 1, or an S-shaped cross section, as in FIG. 4. In this way, it is possible to optimize the segmentation of the storage structure 10 between the first portion 11 and the rest of the storage structure 10. For example, with reference to FIG. 1, it is possible to completely isolate the first portion 11 from the rest of the storage structure 10.

Furthermore, as seen in FIGS. 4 and 5, the storage structure 10 may comprise a second portion 12 extending to the circumferential edge B of the storage structure 10, and connected to the first portion 11. In this case, the first portion 11 is not isolated from the rest of the storage structure 10. This configuration is advantageous to facilitate gas diffusion after desorption.

As can also be seen in FIG. 1, the composition and/or distribution of the storage material in the first portion 11 of the storage structure 10 may be different from the composition and/or distribution of the storage material in the rest of the storage structure 10. Specifically, the storage material in the first portion 11 may be different from the storage material in the rest of the storage structure 10. Alternatively, or as a complement, a thickness of at least one of the first layers 100 configured to store gas by sorption in the first portion 11 may be different from a thickness of at least one of the first layers 100 configured to store gas by sorption in the remainder of the storage structure 10, where thickness is defined as the dimension along the longitudinal axis X-X as defined below. Alternatively, or as a complement, the number of first layers 100 and/or second layers 200, comprising the thermally conductive material, having a higher thermal conductivity than the storage material, to increase heat transfer within the storage structure 10, and compressible in order to deform under the action of forces exerted by the storage material during variations in the volume of the storage material during the gas sorption and desorption phase, in the first portion 11 may be different from the number of first layers 100 and/or second layers 200 in the rest of the storage structure 10. Alternatively, or as a complement, the material and/or a thickness of at least one of the second layers 200 in the first portion 11 may be different from the material and/or a thickness of at least one of the second layers 200 in the rest of the storage structure 10. Alternatively, or as a complement, at least one of the second layers 200 in the first portion 11 may not comprise two and/or three parts 201, 202, 203, while at least one of the second layers 200 in the remainder of the storage structure 10 comprises two and/or three distinct parts 201, 202, 203, with the first part 201 and/or the third part 203 comprising a thermally conductive material, of higher thermal conductivity than that of the storage material, in order to increase the transfers within the storage structure 10, the second part 202 comprising, for its part, a compressible material in order to deform under the action of forces exerted by the storage material during variations in the volume of the storage material during the gas sorption and desorption phase.

Thus, it is possible to optimize the distribution of the heat from the heating means 3 within the storage structure 10, between the first portion 11 and the rest of the storage structure 10. Indeed, during operation, the first portion 11 will tend to heat faster than the rest of the storage structure 10. Therefore, it is possible to have storage and/or second layer 200 materials the mechanical and/or thermal properties of which are more suitable for rapid heating within the first portion 11, and vice versa in the rest of storage structure 10.

With reference to FIG. 1, the storage structure 10 may present a preferred direction defining a longitudinal X-X axis. Such a configuration makes the storage structure 10 particularly easy to store and/or transport. In this configuration, as seen in FIG. 1, the heating means 3 may present a substantially annular structure along the longitudinal axis X-X. In this way the heat distribution within the first portion 11 and within the rest of the storage structure 10 is optimized. Indeed, the heat tends to propagate radially with respect to the longitudinal axis X-X. Therefore, an annular structure of the heating means 3 guarantees the best possible distribution of heat transfer within the storage structure 10. Advantageously, in this case, the heating means 3 are centered around the longitudinal axis X-X, in order to guarantee a symmetrical homogeneity of the heat distribution.

Enclosure and Gas Evacuation

With reference to FIG. 1, a gas evacuation duct 400 can be provided in the first section 11. However, this is not limiting since, as an alternative or as a complement, a gas evacuation duct 400 can also be provided in the rest of the storage structure 10. In any case, such ducts 400 facilitate the transport of the gas during its desorption from the storage material.

With reference to FIGS. 1, and 6 to 8, the storage structure 10 may also comprise an enclosure 4 comprising an outer wall 40, with the storage structure 10 being located inside the enclosure 4. The presence of such an enclosure 4 facilitates the transport and use of the storage device 1. In addition, enclosure 4 enhances the safety of use of the storage device 1 by protecting a user from possible gas leaks and/or high intensity heat transfer.

In order to enhance the protection of the user, but also to facilitate the diffusion of the gas during its desorption from the storage material, the storage device 1 may advantageously comprise a thermal insulation layer 42, located between the storage structure 10 and the outer wall 40 of the enclosure 4. This heat insulation layer 42 is further configured to diffuse gas. In addition, the insulation layer 42 may be in contact with the storage structure 10, to further facilitate gas diffusion, but also to improve the compactness of the storage device 1. However, this is not limiting, since the insulating layer 42 can also be separated from the storage structure 10, for example by a free space, with neither storage material 10 nor second layer 200 material, which can be initially occupied by gas. This latter configuration may be encountered when the materials of the storage structure 10 are not compatible with the insulating layer material 42, or when it is preferable to increase the thermal insulation with the free space.

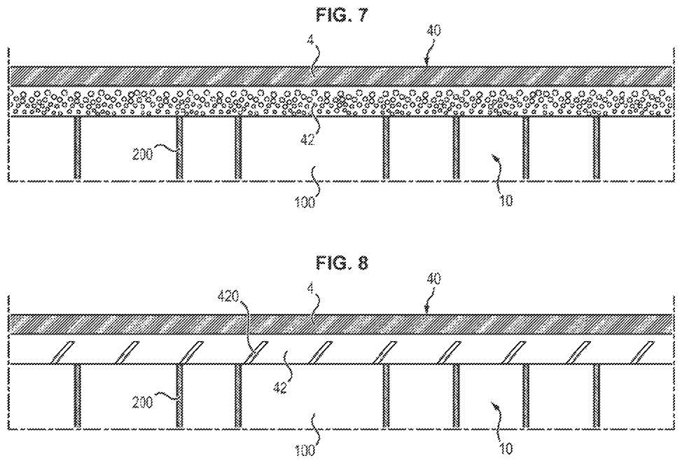

The insulating layer 42 may, in another embodiment, comprise a porous structure, for example with a decreasing porosity gradient from the storage structure 10 to the outer wall 40 of the enclosure 4. This embodiment is illustrated in FIG. 7. In this way, the portion of the insulating layer 42 closest to the storage material can effectively evacuate the gas after desorption, while the portion of the insulating layer 42 closest to the enclosure 4 can effectively insulate from the heat released by the storage structure 10.

Alternatively, or in combination, the insulation layer 42 may comprise a grooved structure. Referring to FIG. 8, the grooves 420 are, for example, provided in the wall of the insulating layer 42 that leads to the storage structure 10. In this way, the portion of the insulation layer 42 closest to the storage material can also effectively evacuate the gas after desorption, while the portion of the insulation layer 42 closest to the enclosure can effectively insulate from the heat generated by the storage structure 10.

In addition, the insulating layer 42 can be formed at an inner wall 44 of the enclosure 4, for example by treating the said inner wall 44, or by applying an additional coating. Such a configuration simplifies the assembly process of the storage device 1. In addition, this method of construction can advantageously lead to a reduction in the maintenance costs of the storage system.

Furthermore, the insulating layer 42 can be a film. In this case, the insulating layer 42 is very thin compared to the thickness of the enclosure 4, for example less than 25% of the thickness of the enclosure, or about 10% of the thickness of the enclosure, preferably 5% of this thickness. This configuration improves the compactness and lightness of the storage device 1, and facilitates its manufacture and maintenance.

In addition, one or more gas evacuation ducts 400 can be provided within the insulating layer 42, as shown in FIG. 1, in order to facilitate the transport of the gas out of the storage device 1 after desorption.

Gas Storage and/or Supply System

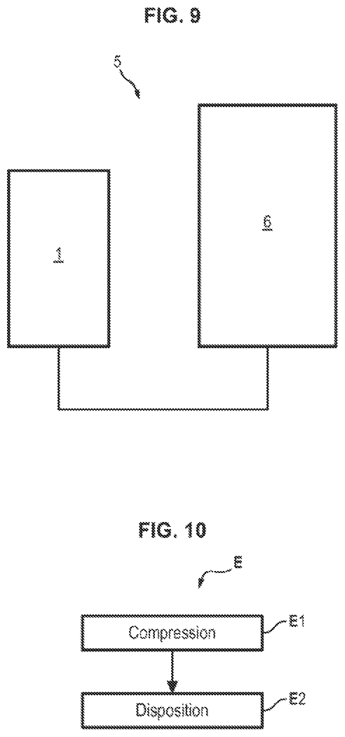

With reference to FIG. 9, a gas storage and/or supply system 5 comprises a sorption gas storage device 1 according to any of the above-described embodiments, and a gas utilization unit 6.

The gas utilization unit 6 may, for example, be a motor vehicle fuel cell where the stored gas is hydrogen.

Method for Manufacturing a Storage Device

With reference to FIG. 10, a method for manufacturing a sorption gas storage device 1 in any one of the previously described embodiments, comprises a compression step E1 of a powder material for gas sorption storage so as to form a first layer 100 of sorption gas storage material in a pre-compressed powder form. In addition, such a method E may comprise a step of disposing E2 of a second layer 200 adjacent to the first layer 100, the said second layer 200 comprising a thermally conductive material of higher thermal conductivity than the storage material.

1. A sorption gas storage device comprising:
a sorption gas storage structure comprising a sorption gas storage material, the said storage structure having a circumferential edge,
a heating means configured to heat the storage material, and to facilitate desorption of the gas, the said heating means comprising:
a first heating section arranged in the storage structure, at a distance from the circumferential edge,
a second heating section arranged in the storage structure at a distance from the circumferential edge on a first hand and from the first heating section on a second hand,
the first heating section and the second heating section defining between them a space in which a first portion of the storage structure extends.

2. The storage device according to the claim 1, wherein the first heating section and the second heating section are connected to each other by a third heating section.

3. The storage device according to claim 1, wherein the storage structure presents a preferred direction defining a longitudinal axis, the heating means presenting a substantially annular structure along the longitudinal axis.

4. The storage device according to one of the claim 1, wherein compositions and/or distributions of the storage material in the first portion of the storage structure are different from compositions and/or distributions of the storage material in the rest of the storage structure, for optimizing the distribution of heat from the heating means within the storage structure.

5. The storage device according to claim 1, further comprising:
an enclosure comprising an outer wall, the storage structure being arranged inside the enclosure, and
a thermally insulation layer arranged between the storage structure and the outer wall of the enclosure, the said layer being further configured to diffuse gas.

6. The storage device according to claim 5, wherein the insulating layer comprises a porous structure.

7. The storage device according to claim 5, wherein the insulating layer comprises a grooved structure.

8. The storage device according to claim 5, wherein the insulating layer is a film.

9. The storage device according to claim 5, wherein the insulating layer is formed at an inner wall (44) of the enclosure (4), by treating the wall, or by applying an additional coating.

10. The storage device according to claim 1, wherein the storage structure comprises:
a first layer comprising a sorption storage material,
a second layer comprising:
a first portion of second layer in contact with the first layer and comprising a thermally conductive material, of higher thermal conductivity than that of the storage material, to increase heat transfer within the storage structure and
a second part of second layer comprising a material being:
compressible to deform under action of forces exerted by the storage material during variations in the volume of the storage material during gas sorption and desorption phases,
of higher compressibility than the first part material, and
thermally conductive, with a thermal conductivity higher than that of the storage material, to increase heat transfer within the storage structure.

11. The storage device according to claim 1, wherein the storage structure comprises:
a plurality of first layers, each first layer comprising the gas sorption storage material in a pre-compressed powder form, and
a plurality of second layers, each second layer comprising a material being:
compressible in order to deform under the action of forces exerted by the storage material during variations in the volume of the storage material during gas sorption and desorption phases, and
thermally conductive, with a thermal conductivity higher than that of the storage material, in order to increase the heat transfer within the storage structure (10), the first and second layers being arranged in an alternating pattern.

12. A method of manufacturing a device according to claim 1 comprising the steps of:
compressing a powder of sorption gas storage material so as to form a first layer of sorption gas storage material in a pre-compressed powder form,
disposing a second layer adjacent to the first layer, the second layer comprising a thermally conductive material having a higher thermal conductivity than the storage material.

13. A gas storage and/or supply system comprising a device according to claim 1, and a gas utilization unit.
